(19) United States
(12) Patent Application Publication
(10) Pub. No.: US 2005/0269199 A1
(43) Pub. Date: Dec. 8, 2005

(54) Process for the plasma sterilization of dielectric objects comprising a hollow part

(75) Inventors: Jerome Pollak, Montreal (CA); Michel Moisan, Outremont (CA); Bachir Saoudi, Montreal (CA); Zenon Zakrzewski, Gdansk (PL)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: VALORISATION-RECHERCHE, Montreal (CA)

(21) Appl. No.: 11/142,904

(22) Filed: Jun. 1, 2005

Related U.S. Application Data
(63) Continuation-in-part of application No. PCT/CA03/01867, filed on Dec. 1, 2003.

(30) Foreign Application Priority Data
Dec. 2, 2002 (CA) CA 2,412,997

(51) Int. Cl. B01J 19/08; B01J 19/12

(52) U.S. Cl. 204/164; 422/186.04

(57) ABSTRACT

There is provided a process for sterilizing a dielectric contaminated object having at least one hollow part. The process comprises (a) producing a plasma by submitting a gas or a mixture of gases to an electromagnetic field; (b) treating the exterior of the object by means of an after-glow of the plasma; and (c) treating the at least one hollow part of the object by means of a discharge of the plasma, the discharge being produced inside the at least one hollow part. Step (c) is carried out before or after step (b). This process is particularly useful for sterilizing various medical or dental instruments. There is also provided a device for carrying such a process.

### CROSS-REFERENCE TO RELATED APPLICATIONS

The present application is a continuation-in-part of PCT international patent application No. PCT/CA2003/001867 filed on Dec. 1, 2003, which claims priority on Canadian patent application No. 2,412,997 filed on Dec. 2, 2002. These applications are incorporated herein by reference in their entirety.

### FIELD OF THE INVENTION

The present invention relates to a process for the sterilization of dielectric objects. More particularly, the invention relates to the plasma sterilization of dielectric objects containing hollow parts. Such objects can be contaminated, as example, with microorganisms and also with non conventional contagious agents such as pathogenic prions.

### BACKGROUND OF THE INVENTION

Traditionally, in hospital quarters, sterilization of surgical instruments is carried out by impregnating them with fluids having anti-bacterial and/or antiviral effects, such as glutaraldehyde or hydrogen peroxide.

Other methods commonly used for the sterilization of contaminated objects are based on a high temperature thermal treatment of the objects. These processes however are disadvantageous in that they significantly cause damage to a large number of polymers that constitute, in whole or in part, medical and dental instruments.

Finally, sterilization methods which combine a thermal treatment with a treatment using a disinfecting liquid have been proposed. However, in addition to constituting more complex operations, these methods have the disadvantage of being associated with operations that are long lasting.

Recently, new techniques of plasma sterilization have been proposed. Patent Applications EP-00.930.937.8 and CA-A-2,395,659 describe these processes as well as devices permitting the sterilization of medical objects by resorting to plasma after-glow, for example containing argon or a mixture of N₂—O₂. These process and devices have shown themselves to be particularly adapted to the sterilization of objects for medical use, such as scalpels or surgical forceps, which are deprived of cavities of a diameter smaller than a few millimeters and a length exceeding one meter.

These processes are indeed of limited application with respect to the disinfection of objects having deep cavities such as ducts. The reason is that such objects have low hydrodynamic conductance, which makes it difficult to circulate a gas therein, at high speed, a condition that is nevertheless required for using active species (emitters of UV and radicals), with limited life span, which are produced in a plasma source outside the duct (so-called after-glow process), in order that the latter manage to inactivate microorganisms on the entire internal surface of such duct. On the other hand, a particular limitation with plasma sterilization (whether by exposure in the discharge itself or in its after-glow) resides in the treatment of pre-wrapped objects, which is a common way of dealing with all presently known sterilization techniques. As a matter of fact, the passage of the active species of a plasma or of its after-glow through the wrapping importantly reduces the flux that reaches the surfaces of the object to be sterilized.

U.S. Pat. No. 5,393,490 describes a process for the sterilization of the surface of contaminated objects by exposing same to the electrically neutral species of an electrical discharge, while maintaining the volume without luminescence and substantially free of field by interposing a barrier between the contaminated objects and the discharge. The barrier (a metallic grid) is transparent to the neutral species and opaque with respect to the charged species that emanate from the discharge. In this case, the flux that reaches the contaminated objects is not a plasma but rather an after-glow. The temperature is kept low therein by operating cooling systems and selecting the gas(es) used to produce the after-glow. The nature of these gases, particularly that of fluorinated gases, is often such that an accelerated degradation of the treated objects if to be foreseen.

U.S. Pat. No. 5,302,343 describes a similar method of sterilization for the decontamination of the surface of contaminated objects by exposing them to neutral sterilizing species.

U.S. Pat. No. 6,589,481 describes the use of a pump system for the sterilization of lumen in the presence of peroxide.

U.S. Pat. No. 3,948,601 describes an entirely after-glow treatment of the inside and the outside of a contaminated object.

International Application WO02070025 describes a process of plasma sterilization in which the contaminated objects are placed in a chamber under atmospheric pressure.

A need therefore existed for a sterilization method that is devoid of at least one of the limitations of the methods of the prior art while allowing, for example, a safe, rapid, economical and/or highly performing sterilization with respect to its purpose.

### SUMMARY OF THE INVENTION

According to one aspect of the present invention, there is provided a process for sterilizing a dielectric contaminated object having at least one hollow part. The process comprises:

a) producing a plasma by submitting a gas or a mixture of gases to an electromagnetic field;

b) treating the exterior of the object by means of an after-glow of the plasma; and

c) treating the at least one hollow part of the object by means of a discharge of the plasma, the discharge being produced inside the at least one hollow part,

step (c) can be carried out before or after step (b).

According to another aspect of the present invention there is provided a process for sterilizing a dielectric contaminated object having at least one hollow part. The process comprises:

a) producing a first plasma by submitting a gas or a mixture of gases to an electromagnetic field;

b) treating the exterior of the object by means of an after-glow of the first plasma;

c) producing a second plasma by submitting a gas or a mixture of gases to an electromagnetic field; and

d) treating the at least one hollow part of the object by means of a discharge of the second plasma, the discharge being produced inside the at least one hollow part.

Step (c) can be carried out before or after step (a) and/or step (b), and step (d) is carried out after step (c).

It has been found that the processes of the present invention permit to sterilize contaminated objects having at least one hollow part with very high performance and without degradation of the sterilized objects.

According to another aspect of the invention, there is provided a device for sterilizing a dielectric contaminated object and having at least one hollow part. The device comprises:
a sterilization chamber adapted to receive the object;
a first plasma source in communication with the chamber, and adapted to produce a plasma to be used for treating the exterior of the object through an after-glow;
a second plasma source in communication with the chamber, and adapted to produce a plasma to be used for treating the at least one hollow part of the object by means of a discharge, the second source comprising a mouthpiece dimensioned so that when the latter is coupled with the hollow part of the object, the discharge is produced inside the hollow part; and
an outlet in communication with the chamber and allowing to exhaust gases produced in the chamber.

The present invention also provides another process for the sterilization of contaminated objects comprising hollow parts. This process includes at least one step in which the presence of an electromagnetic field, whether intrinsically generated by surface wave propagation, or applied from the outside, generates a plasma in the hollow parts of the contaminated object. This treatment may be combined with the sterilizing treatment of a plasma after-glow. Sterilization of the thus treated contaminated objects has the advantage for example of being carried out with very high performance and without degradation of the treated objects.

Another aspect of the present invention relates to a process that allows sterilization of a contaminated dielectric object, the latter including at least one hollow part. This process includes at least one step in which at least one electromagnetic field, having a sufficient intensity to produce a plasma inside a gas or a mixture of gases introduced into the hollow part(s) of the contaminated object, is directly applied from outside the contaminated object to the hollow part(s) or is intrinsically produced inside the hollow part(s) of the contaminated object. This process also permits to simultaneously treat a plurality of contaminated objects.

By way of example of an electromagnetic field that is directly applied from the outside, the case of linear applicators may be mentioned.

By way of example of an electromagnetic field that is intrinsically produced inside the hollow surfaces, the one associated with surface waves, that are propagated by means of a plasma that they produce along the object whose interior is intended to be sterilized, may be mentioned.

Within the framework of the present invention, surface wave means a wave in which the propagation support is a (or a plurality of) dielectric medium or media. When implementing the processes of the present invention, two dielectrics are involved, that of the hollow object and that constituted by the plasma itself. As a matter of fact, the latter may indeed be considered as a dielectric medium.

Within the framework of the present invention, a dielectric object is a material that is globally of very low electrical conductivity or is transparent with respect to electromagnetic fields (EM) and in a manner that it does not significantly heat under its action.

Among undesirable micro-organisms that can be destroyed, viruses, spores, bacteria, fungi, mildews and prions may be mentioned.

When implementing the processes of the invention, the contaminated objects, as well as eventually the corresponding wrapping, can be directly treated alternately by plasma after-glow and with an electromagnetic field of a sufficient intensity to produce a plasma inside the hollow parts.

According to a preferred embodiment of the invention, the electromagnetic field is one produced by a surface wave that is propagated simultaneously inside and outside the hollow tube of the contaminated object and this result is obtained through the plasma that is produced inside the hollow tube.

According to another advantageous embodiment, the electromagnetic field is applied inside the hollow part(s) of the contaminated object, from the outside of the contaminated object. This is carried out for example by means of a linear applicator.

Preferably, the walls and the mass in volume of the hollow part(s) of the contaminated object essentially consist of a dielectric material.

Advantageously, the main steps of the processes of the invention may be summarized as follows:
a) direct treatment of the hollow part(s) of the contaminated object by plasma sterilization generated by at least on electromagnetic field, preferably one produced with an electromagnetic surface wave that is propagated on the internal or external surfaces of the hollow part(s); in this case, the outside of the hollow tube is preferably under so-called primary vacuum, i.e. at a value that varies from (10 to 50 mTorr); and
b) treating the contaminated object, preferably essentially its exterior, by after-glow sterilization obtained with a plasma generator.

A plasma is generally a gas medium, in which there are electrically charged species, such as electrons and ions, and also electrically neutral species. A plasma may be obtained by applying a sufficiently intense electrical field to the gas so as to obtain an electrical discharge in this gas. The species that are present in the after-glow have been brought therein by a gas flow from the zone where the plasma was produced. Recombination of the ions and electrons to reform neutral particles is extremely fast, faster than the time necessary for the species to end up in the after-glow zone. Essentially, only neutral species thereafter remain in the latter, in their fundamental or excited state, including their ionized state.

The processes of the invention may be used not only for the sterilization of an object that has been contaminated, but also to its wrapping. The process can then include the following steps that consist in:
a) treating the hollow part(s) of the objects by plasma sterilization that is directly produced in the hollow part(s) with an electromagnetic surface wave that extends on the internal and external surfaces of the hollow part(s);
b) treating the contaminated object by sterilization that is carried out by after-glow;
c) treating the wrapping by sterilization that is carried out by after-glow; and
d) introducing the hollow object that has been sterilized in the sterilized wrapping, while operating in a sterile medium.

Steps a), b) and c) may be carried out in any indifferent order, one step following the other, or simultaneously.

The joint sterilization of a contaminated object and of its wrapping of matched size and shape, is preferably carried out in a sterilization chamber provided with a device allowing the production of an after-glow by plasma, as well as a device allowing the production of an electromagnetic surface wave in the hollow parts of the contaminated object. Air that is initially present in the chamber is advantageously removed to a pressure that is preferably reduced to between 10 and 50 mTorr.

This step is followed by sterilization of the contaminated object by subjecting it to sterilization by after-glow, and by a step in which the wrapping is subjected to sterilization by after-glow and thereafter a step, in which the internal part(s) of the hollow contaminated object are subject to sterilization by means of the plasma generated by the electromagnetic surface wave that preferably extends along the entire length of the duct. These various steps may be carried out in any given order.

The processes of the invention give particularly advantageous results when the contaminated object is a cylindrical hollow duct. The dimensions of this duct are advantageously selected so that the ratio obtained by dividing the length of the constitutive cylinder of the contaminated object by the diameter of the cylinder is between 5.10³ and 0.3.10³.

Sterilization by after-glow is carried out by one of the processes described in European Application EP-A-00.930.937.8, more particularly in the corresponding claims as well as in International Application WO 2004/011039, more particularly in the corresponding claims. These documents are incorporated by reference in the present application. The content of Applications CA-A-2,395,659 and CA-A-2,273,432 is also incorporated by reference.

This type of discharge advantageously corresponds to a plasma comprising sterilizing species generated in situ by subjecting a gas flow comprising between 0.5 and 20% atomic oxygen, to an electrical field that is sufficiently intense to generate a plasma. The sterilizing species cause destruction of the micro-organisms. It should be noted that the gas has no biocidal property before its passage into the electrical field, and that the percentage of atomic oxygen in the gas flow is adjusted in a manner to obtain an UV radiation of maximum intensity. Preferably, exposure takes place in the after-glow zone or in the excitation zone of the plasma.

The electrical field of the discharge is then advantageously generated by a micro-wave discharge and the sterilizing species comprise for example photons, radicals, atoms and/or molecules.

Advantageously, in addition to atomic oxygen, the gas flow used comprises nitrogen, neon, argon, krypton, xenon, helium, oxygen, carbon monoxide, carbon dioxide, nitrogen oxides, air, and mixtures thereof.

According to another variant, in addition to atomic oxygen, the gas flow comprises nitrogen, argon and mixtures thereof, preferably the proportion of oxygen in the gas flow varies between 2% and 5%.

Temperature in the after-glow is preferably lower than or equal to 500 Celsius. This after-glow treatment is indifferently carried out in isolated fashion or repetitively in a multi-step sequential process.

The after-glow steps that can be considered comprise for example a pulsed gas in a direct electrical or electromagnetic field, a pulsed field in a gas in continuous flow, a pulsed gas in a synchronously pulsed field, a gas change, or a mixture of these steps.

A sterilization device that can be used to carry out such sterilization by after-glow is also described in Patent Application EP-A-0.0930.937.8 as comprising a plasma source associated with a sterilization chamber through a discharge tube in which there is injected a gas or a mixture of gases possibly giving the plasma, the chamber comprising an object to be sterilized, and a vacuum pump to bring in the gases into the chamber to keep it under reduced pressure. The plasma source comprises an EM field applicator such as a surfactron or a surfaguide. The sterilization chamber is entirely or partially made of Pyrex™ or of aluminum, for example.

A process for sterilizing contaminated objects by after-glow is described in Application WO 2004/011039 mentioned above.

This process is carried out in a sterilization chamber that is provided with at least one discharge duct. The discharge duct(s) open(s) into the sterilization chamber and is (are) supplied with a liquid or gas supply flow. The contaminated objects are treated in the sterilization chamber with sterilizing species that are present in a zone of after-glow or in a zone of excitation of a plasma that is produced, at the level of the discharge duct(s), by subjecting the gas supply flow to an electrical field and in which the ratio R=(SCD)/(SCS), in which (SCD) represents the cross-section of the discharge duct in contact with the sterilization chamber or the sum of the cross-sections of the discharge duct(s) and (SCS) is the cross-section of the sterilization chamber (SCS), agrees with the relation 0.05<R<0.70.

Preferably, the structural characteristics of the sterilization chamber are selected so that R agrees with the relation 0.09≦R≦0.60, still more preferably 0.15≦R≦0.5. According to a particularly interesting embodiment 0.2≦R≦0.40, preferably R is about 0.25.

The electrical field that generates the plasma is advantageously a high frequency field whose frequency is normally between 10 Megahertz and 3 Gigahertz, and which varies from 100 to 2450 MHz. According to a still more advantageous embodiment the frequency is between 200 and 915 MHz.

The gas supply flow may be adjusted by controlling the flow and/or the gas pressure in the chamber, so as to obtain an Ultra Violet (UV) radiation of maximum intensity. It is advantageously selected so that it flow is between 50 and 3000 cm³ per minute.

The pressure that is generated inside the sterilization chamber is between 0.1 and 10 Torrs.

The gas flow supply advantageously comprises argon and the pressure that is generated inside the sterilization chamber is between 0.1 and 4 Torrs.

According to another variant, the gas flow comprises nitrogen and molecular oxygen and the pressure that is obtained inside the sterilization chamber is between 1 and 8 Torrs.

The gas flow supply includes at least one component selected from the group consisting of molecular oxygen, nitrogen, neon, argon, krypton, xenon, helium, oxygen, carbon monoxide, carbon dioxide, gases of formula NOₓ, in which x represents a whole number selected from the group consisting of 1, 2 or 3, air, and mixtures of at least two or more of these gases.

According to an advantageous embodiment, the gas flow supply includes molecular oxygen. Preferably, the gas flow includes at least 0.10% molecular oxygen, still more advantageously at least 0.04% molecular oxygen.

According to another interesting embodiment, in addition to molecular oxygen, the gas flow supply includes at least two other gases.

Thus, in addition to molecular oxygen, at least three other gases that may for example include nitrogen, argon and helium or nitrogen, argon and nitrogen dioxide, or still molecular oxygen, xenon or krypton may be present in the gas flow supply.

The gas flow supply can be between 10 and 5000 cm³ standard per minute, preferably this flow is between 50 and 3000 cm³ per minute.

When the gas flow consists of NO₂, nitrogen, or an oxygen-nitrogen mixture, the pressure inside the sterilization chamber can be between 2 and 8 Torrs.

By way of illustration, the gas flow can have the following composition:

from 0.04 to 30% O₂,

from 0.05 to 99.91% nitrogen; and

from 0.05 to 99.91% argon.

Or, the gas flow can have the following composition:

from 0.04 to 30% O₂;

from 0.05 to 99.91% nitrogen; and

from 0.05 to 99.91% krypton.

Or still, the gas flow can have the following composition:

from 0.04 to 30% O₂;

from 0.05 to 99.91% nitrogen; and

from 0.05 to 99.91% xenon; or

from 0.05 to 99.91% neon.

According to another advantageous embodiment, the gas flow can have the following composition:

from 0.04 to 98.5% O₂;

from 0.05 to 99.6% nitrogen;

from 0.05 to 99.6% xenon; and

from 0.05 to 99.6% neon.

Preferably, the gas flow includes from 0.1 to 10% O₂, still more preferably it includes from 0.2 to 5% O₂.

Among the sterilizing species thus produced in the after-glow, photons, radicals, atoms and/or molecules may be mentioned. The photon and/or radical population are important, and may even constitute the most important part.

According to another interesting variant of sterilization step by after-glow, the contaminated objects are exposed, in a sterilization chamber, to a plasma that is generated in at least one discharge duct that opens in the chamber, from a N₂ gas flow, the plasma comprising sterilizing species produced when subjecting the gas flow to an electrical field that is sufficiently intense to produce the plasma. This process comprises exposing contaminated objects to the sterilizing species, this exposure taking place in a zone of after-glow or in a zone of plasma excitation and it is characterized in that:
the percentage of molecular oxygen in the flow of gas N₂ is adjusted to a content x, of molecular oxygen, such that 0<x<0.5 (x preferably varying from 0.1 to 0.4%), preferably by controlling the flow and/or by controlling gas pressure in the chamber, so as to obtain an UV radiation of maximum intensity;
molecular oxygen is at least partly converted into atomic oxygen; and
the cross-section of the discharge duct at its inlet into the sterilization chamber (SCD) and that of the sterilization chamber (SCS) agree with the relation 0.05<(SCD)/(SCS)<0.7,
   cross-section (SCD) again representing the cross-section of the discharge duct in contact with the sterilization chamber and which is perpendicular to the direction of the gas flow that feeds the discharge duct and cross-section (SCS) representing the cross-section of the chamber in contact with the discharge duct and that is perpendicular to the plasma flow.

As a variant for the production of an after-glow that is suitable for the implementation of the sterilization processes according to the invention, one may mention the exposure of the contaminated objects to a plasma that is generated in at least one discharge duct that opens into a sterilization chamber, and this from a gas flow including at least one of the gases of the group consisting of oxygen and rare gases such as helium, neon, argon, krypton and xenon, the plasma comprising sterilizing species generated when subjecting the gas flow to an electrical field that is sufficiently intense to generate the plasma, the process is characterized in that:
the gas flow is adjusted, preferably by controlling the flow and/or by controlling the gas pressure inside the chamber, so as to obtain an UV radiation of maximum intensity; and
the cross-section of the discharge duct at its inlet into the sterilization chamber (SCD) and that of the sterilization chamber (SCS) agree with the relation 0.05<(SCD)/(SCS)<0.70.

The temperature inside the sterilization chamber is advantageously 60° Celsius or less, and preferably this temperature is about 30° Celsius. Exposure to after-glow lasts between 10 minutes and 4 hours.

This treatment step by after-glow may be carried out in isolated fashion or in a repeated manner in a multi-step sequential process, for example by using a pulsed gas in an electrical or electromagnetic field that is applied in a continuous manner, a pulsed electrical field in a gas in continuous flow, or in a pulsed gas in a synchronously pulsed electrical field, a gas change; or a combination of these steps.

Within the framework of the present invention, a mixture of N₂—O₂ is preferably used to produce the after-glow, which makes it possible to obtain an excellent uniformity of distribution of the active species in the sterilization chamber.

Advantageously, in the step where the contaminated object is treated with an after-glow, the object is of the hollow duct type including at least two free ends, each end being provided with a mouthpiece and being placed in the sterilization chamber so that the first mouthpiece is in contact with a surface wave exciter and the second mouthpiece is connected to a pump system that exhausts the discharge effluents and, possibly, micro-organism parts, that are expelled in gas form outside the sterilization chamber.

The processes of the invention give particularly interesting results when decontaminating endoscopes, catheters and generally hollow ducts with parallel axes disposed in a cylindrical or oblong wrapping.

The parameters of the useful cycle of electromagnetic power (hereinafter called EM) produced during sterilization, for example when it operates and when it is stopped, are advantageously adjusted to prevent any damage to the wall of the channel duct, resulting from heating.

The useful power cycle EM (of the surface wave) for its part is adjusted to a value between 1 and 100%.

Treatment of the hollow part(s) with the electromagnetic surface wave preferably lasts between 45 and 120 minutes, preferably about 60 minutes and/or the temperature in the hollow tube is between 30 and 60 degrees Celsius, preferably between 30 and 45 degrees Celsius.

The excitation frequency of the plasma produced in the hollow part(s) of the contaminated object is between 10 khertz and 10 GigaHertz, preferably this frequency is between 1 MHertz and 2500 MHertz.

The wrapping, disposed in the chamber as well as the duct, is kept opened at one end and is subject to sterilization through the after-glow or the surface wave. The opened side of the wrapping is then preferably oriented to face the source of plasma that produces the after-glow.

Once sterilization of the contaminated object is over, the object is transferred, while keeping it in a sterile environment, in the wrapping that is present in the chamber.

It is then advantageous to proceed to the sealing of the wrapping containing the object inside the sterilization chamber, for example by thermo-welding.

The contaminated object and/or the wrapping are preferably placed on removable supports independently provided in the sterilization chamber. During the process, these supports are possibly moved upwardly and laterally, depending on the needs of the sterilization steps and as a function of the size and shape of the objects to be decontaminated.

By way of illustration, a surface wave generator of the type SURFAGUIDE such as the one sold by Liquid Air, under the reference UPAS, may be used.

Under these circumstances, the operations of moving objects and/or the support inside the sterilization chamber are carried out in a sterile environment, by means of an articulated arm that is controlled from the outside.

The electromagnetic surface wave exciter is disposed at one end of the duct(s) to be sterilized or, coaxially with respect to the duct, at any point along this object.

The electromagnetic field applicator may be an applicator of the capacitive type.

The EM field applicator of the capacitive type may then consist of conductive plates disposed in parallel. The parallel plates may be coated with a dielectric material and are disposed on either part of the object to be decontaminated. These plates are advantageously supplied with an EM power generator.

The electromagnetic field applicator advantageously consists of turns that produce an electromagnetic field in the dielectric duct, and this field leads to the formation of a plasma in the hollow parts of the object to be sterilized.

The external faces of the hollow duct(s) to which hollow mouthpieces have been fixed (which prevent sterilization) are subject to sterilization while in the absence of the mouthpieces, during the same step as the one used to sterilize the outer part of the contaminated object and/or its wrapping.

Another aspect of the present application consists of a sterilizing device including a sterilization chamber, the chamber being provided with a source of after-glow and a generator of surface waves and/or a linear shaped EM field applicator, the latter two being capable of producing a plasma in the hollow part of a dielectric object.

The sterilizing chamber of this device is supplied with a plasma after-glow and is provided with a surface wave generator. The sterilizing chamber may also include means adapted to handle the objects disposed therein in a sterile manner.

The device is provided with a device for exhausting the gases from the plasma that is formed in the sterilization chamber, outside the chamber.

Another aspect of the present invention consists of a process for sterilizing contaminated dielectric objects, including at least one hollow part, the objects being disposed inside a sealed or non sealed wrapping. This process includes at least one step in which at least one electromagnetic field is produced inside the hollow part(s) of the contaminated objects and/or inside the wrapping.

Many objects may also be present simultaneously in the same sterilizing chamber and by implementing the process of the invention.

There is a definite advantage to proceed in two steps to sterilize contaminated objects, especially because it is difficult and even impossible with certain gases, to efficiently produce a discharge, simultaneously, inside a tube and on its outside, when the two media are in the same gas at the same pressure.

The process as described in U.S. Pat. No. 5,302,343 and U.S. Pat. No. 6,589,489 issued to Jacob requires the use of a barrier that filters the charged particles and only allows neutral particles to pass therethrough. Under these operating conditions, the neutral species will not easily penetrate inside the hollow tube rapidly enough to remain active. Indeed, a gas cannot circulate at high speed (essential condition for the species to remain active) inside a tube of very small diameter without producing a large pressure gradient, i.e. very high pressure at the gas admission side and low pressure at the pump side. Thus, the conditions for UV optimization are met only along a small linear section of the interior of the hollow tube.

Under these circumstances, the process according to the invention is faster and therefore more efficient.

The process according to the present invention solves this problem by using a gas stream which is nearly stationary (static) and by producing a plasma therein that will be the same all along the discharge tube, thereby ensuring the same sterilization efficiency along a hollow tube, such as an endoscope.

The surface wave that is used is of the EM wave category: see in this respect the publication of Margot and M. Moisan, Characteristics of surface-wave propagation in dissipative cylindrical plasma columns, J. Plasma Physics, vol. 49, pp 357-374 (1993).

A linear applicator such as described in Sauve et al. (1995) IEEE Transactions on Plasma Science, vol. 43, pp. 248-256 can also be used to impose an EM field inside the hollow parts, the EM field not being produced by a surface wave, but rather with a leaky wave.

Another advantage of the present plasma sterilization process resides in the fact that the temperature of the discharge gas (T_{g}) remains in sufficiently weak operation either (case of the surface wave) because the EM wave operates in batch (notion of impulsion), or also because the frequency of this wave is decreased, or still (case of the linear applicator) by operating in such a way that the EM power output that is produced by the field applicator is weak (for example, by making sufficiently small holes in the wave guide in which the EM wave, that is produced by the micro-wave generator, circulates).

While the methods described in U.S. Pat. No. 5,302,342 and in U.S. Pat. No. 5,393,490 advocate either to cool the outer wrapping of the system to reach this goal, or to modify the nature of the gas mixture. Within the framework of the present application, to reach an optimization of the intensity of UV emission, one plays around with the composition of the mixture or its pressure. Generally, it is not possible to simultaneously reach a UV optimization and a reduction of the T_{g}.

### BRIEF DESCRIPTION OF THE DRAWINGS

In the following drawings which represent by way of examples only particular embodiments of the invention:

FIGS. 1A and 1B schematically represents a device for plasma sterilization according to a particular embodiment of the present invention. Such a device is used for carrying out a process according to a particular embodiment of the invention. Sterilization is carried out in two steps in which the order may vary i.e. the step shown in FIG. 1A can be carried out before or after the step shown in FIG. 1B. FIG. 1A corresponds to the sterilization of the outside of a hollow tube and its wrapping while FIG. 2A corresponds to the sterilization of the inside of the hollow tube in which a gas circulates; in this case, a chamber containing the hollow tube is under reduced pressure: no gas circulates therein. The parts that are colored in gray are filled with a gas capable of producing a plasma and the parts that are not colored are under vacuum. The flow of gases used is controlled by means of flow-meters.

FIGS. 2A and 2B schematically represent another device for plasma sterilization according to a particular embodiment of the present invention. FIGS. 2A and 2B each represents a step carried out during a process according to a particular embodiment of the invention. As indicated for FIGS. 1A and 1B, the step of FIG. 2A can be carried out after or before the step of FIG. 2B. In FIG. 2A, sterilization of the outside of a tube and its wrapping is shown, while in FIG. 2B, sterilization of the inside of the tube is shown.

FIG. 3 represents an assembly, according to a particular embodiment of the invention, for using wave surface propagation to produce a plasma inside a hollow tube made of a dielectric material without damaging the latter by heat; this is made possible by controlling gas temperature and adjusting the time during which the electromagnetic wave is produced in the gas discharge.

FIG. 4 represents the serrated pulse that guides the oscillator which feeds the amplifier that produces the electromagnetic power that is required to give the electrical discharge in a device according to another embodiment of the present invention.

FIG. 5 shows a way to easily verify the sterilizing activity of a device according to another embodiment the invention by inserting a thin Teflon™ tube section inside the discharge tube. This section was previously contaminated with 50 μliter of a suspension containing 10⁶ spores of B. subtilis.

FIG. 6A is a schematic representation of the principle of using an applicator of linear geometry to feed a discharge tube, that, in itself, is co-linear, and such as described in the publication of G. Sauve, M. Moisan, Z. Zakrzewski, C. B. Bishop. IEEE Transactions on Antennas and Propagation, 43, 248-256 (1995).

FIG. 6B represents a power distribution associated with using the applicator of FIG. 6A.

FIG. 7A shows a particular type of linear applicator, according to another embodiment of the invention, so-called tri-plate system, in conformity with the schematic diagram of FIG. 6A but particularly adapted to the simultaneous sterilization of a plurality of hollow tubes. This device operates, in this example, at the frequency of 915 MHz. The figure represents an experimental device according to the invention that makes use of a tri-plate applicator. Element (1) represents an HF generator, (2) an adapted charge, (3) a circulator, (4) a bi-directional line, (5) a trigger-circuit (switch), (6) a bolometer, (7) a bottle of gas, (8) a gas flux dividing system, (9) a short-circuit piston for impedance tuning, (10) a tri-plate applicator and (11) a pumping system.

FIG. 7B represents a cross-section view taken along the lines 7B-7B of FIG. 7A.

FIG. 7C represents a top view of the device of FIG. 7B, wherein parts have been omitted for illustration purposes.

FIG. 7D represents a side view of the FIG. 7B, wherein parts have been omitted for illustration purposes.

### DETAILED DESCRIPTION OF PREFERRED EMBODIMENTS OF THE INVENTION

The preferred embodiments described hereinafter are given by way of example only and should not be interpreted as constituting any kind of limitation to the scope of the present invention.

It has been shown that the processes of the invention can achieve with success sterilization of hollow cylinders with small diameters (preferably with a diameter between 0.5-4 mm) and which are very long (preferably between 1.0-2.5 m). Such cylinders are reputed to be interiorly very difficult to sterilize with an after-glow flux.

The propagation of a surface wave inside the duct generates a plasma (discharge) in the hollow part of the dielectric duct to be decontaminated. The operating conditions are optimized in such a manner that sterilization takes place without causing damages to the internal wall of the duct.

On the other hand, the outer part of this duct may be sterilized with a plasma after-glow, using techniques that are the object of European Application number EP-A-00.930.937.8 and International Application WO 2004/011039.

According to an advantageous embodiment of the present invention, it is proposed to sterilize objects outside any wrapping thereof and to proceed to their wrapping only when the sterilization cycle is over.

After having initially placed the required wrapping in the same chamber as the product to be sterilized, it is first sterilized by after-glow and this preferably takes place at the same time as the object to be wrapped. The object is then transferred, under the sterile environment of the chamber, into the wrapping, for example, by means of articulated pliers. The wrapping is then closed and sealed, for example, by thermo-welding.

A new sterilizer that is adapted for the implementation of the process according to the invention calls for two sterilization modes, namely plasma after-glow and surface wave plasma which are sequentially operated in the same chamber. This device therefore comprises two plasma sources (supplied for example by means of micro-waves) with their electrical field applicator (a wave launcher in the case of surface wave plasma). This system, which consists of a single sterilization chamber, is kept under reduced gas pressure, in the presence of a gas flow.

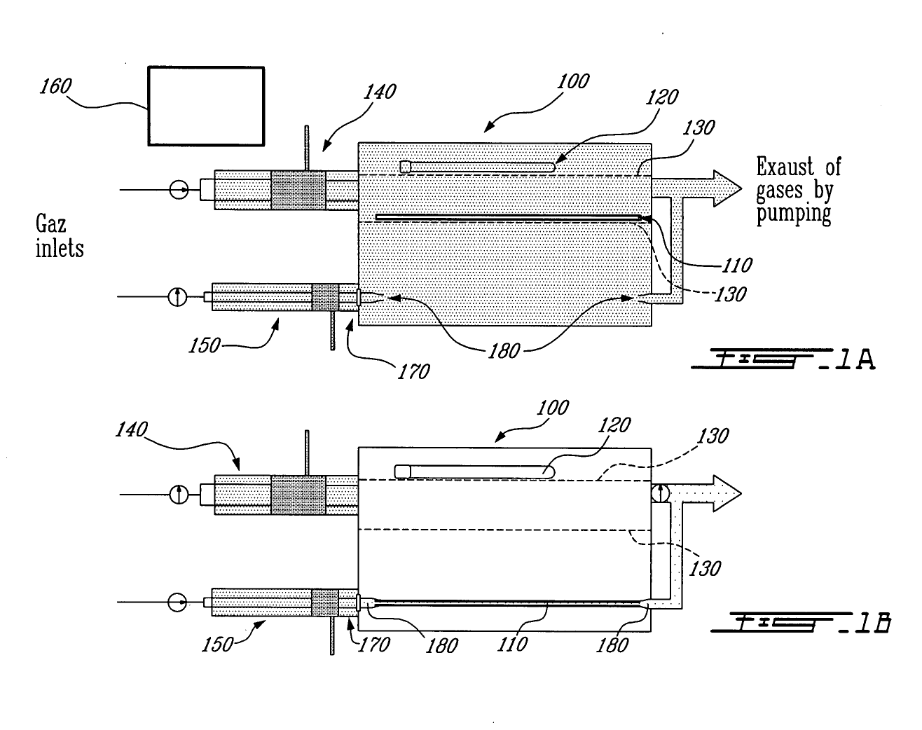

The processes of the invention can advantageously be carried out in a device as illustrated in FIGS. 1 to 13 of International Application No WO 2004/011039. It includes a plasma source coupled to one of the walls of the sterilization chamber by means of at least one discharge tube in which there is injected a gas or a mixture of gases possibly generating the plasma, the chamber comprising the objects to be sterilized, and a vacuum pump to bring in the gases into the chamber and keep it under reduced pressure. The plasma source comprises an electrical field applicator and the ratio R agrees with the relation 0.05<R<0.7. By way of example, the electrical field applicator is of the surfatron or surfaguide type.

Use of a Surface Wave Plasma

When the material of the duct is based on polymers, therefore generally a good dielectric, it is possible to use the dielectric nature of its structure to make it a propagation medium for an electromagnetic (EM) surface wave which, at the same time, will produce and maintain a plasma inside the duct. There is thus produce a plasma inside the channel without having to introduce a conductor therein (an electrode), as this would be required if a direct current discharge would be intended (electrical field of constant intensity), for example.

Maintenance of a plasma column, inside a dielectric (glass, molten silica, for example) duct (tube), with an EM surface wave guided by this tube is described in the publication of M. Moisan and Z. Zakrzewski, entitled “Plasma Sources Based on the Propagation of Electromagnetic Surface Waves”, J. Phys. D: Appl. Phys. 24, 1025-1048 (1991).

Other types of plasma may be used for the same purposes. Thus, those produced by a capacitive type discharge could be used. In this case, the hollow duct is placed between the two plane electrodes disposed in parallel relationship and supplied with an EM field. It is also possible to use a plasma that is produced by an inductive type of excitation, such as one which is advantageously produced inside the hollow tube when the latter is placed inside turns, that extend coaxially to the tube, and are supplied with an EM field.

Implementation

In order not to overly heat the duct, which could damage it, a wave excitation frequency that is preferably equal to or lower than 200 MHz is used.

Thus, the density of the plasma produced is limited. The temperature of the gas (heated by electronic collisions) is therefore reduced.

A lower temperature may be obtained or a higher frequency may however be used while the temperature of the gas is not too high, provided however that there is used a type of supply, by impulsion, of the EM output applied, that is characterized by sufficiently long idle periods.

This result is obtained by resorting, for example, to a modulation in gaps (FIG. 4) or still, to a sinusoidal modulation, of the output of the generator. The length of the idle period of the gap is selected so as to avoid exceeding a maximum temperature. A decrease of the EM wave frequency and the duration of the operation and idle periods of the EM output impulsion may also be combined so as not to exceed a desired optimum temperature.

In the examples that are presented herein, the process for sterilizing the duct is carried out following a plurality of steps, in a device such as illustrated in FIGS. 1A and 1B. A hollow tube (110), for example an endoscope and its wrapping (120), are placed on dielectric supports (130) in a sterilization chamber (100). A source of plasma (140) for producing an after-glow is connected to the upper part of the sterilization chamber (100) and the surface wave exciter (150) is connected to the lower part of the sterilization chamber (100). A microwave generator (160) is connected to the source of plasma (140) and a dielectric channel (170) is connected to the exciter (150). Arrow orientations indicate if the valve that controls gas circulation is opened (tube direction) or closed (orientation perpendicular to tube axis). In the first step of the process illustrated in FIG. 1A (note that the order of the steps shown in FIGS. 1A and 1B may be reversed), the inside as well as the outside of the wrapping (120) as well as the hollow tube (110) are sterilized.

The outside of the tube (110) is carefully sterilized in an efficient manner. However, in view of the difficulty to rapidly circulate a gas flow inside a hollow tube (110) of small diameter, the inside of the tube is imperfectly sterilized. In the second step shown in FIG. 1B, the inside of the endoscope is directly sterilized by propagating a surface wave that produces a plasma inside the hollow tube (110). When sterilizing the inside of the hollow tube (110) as shown in FIG. 1B, the tube (110) is connected at each end to a mouthpiece (180).

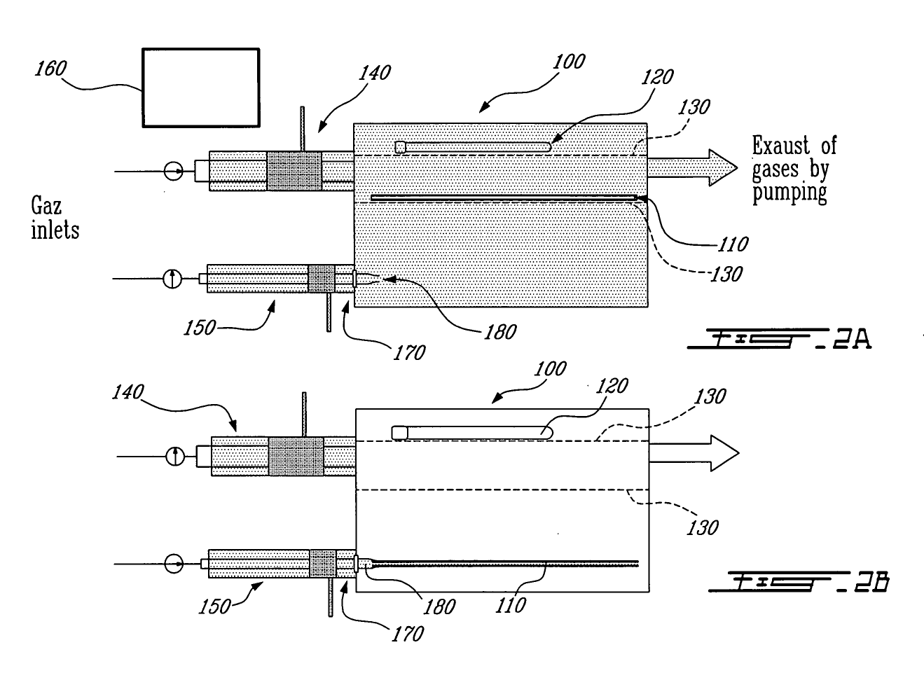

The processes schematically represented in FIGS. (1A and 1B) and (2A and 2B) are similar. They differ only in the way the inside of the tube (110) is sterilized (see FIGS. 1B and 2B). In fact, the device used in FIG. 1B is slightly different than the one used in FIG. 2B. In FIG. 2B, as opposed to FIG. 1B, one of the end of the hollow tube (110) to be sterilized is free i.e. no mouthpiece (180). Exhaust of gases from the plasma is carried out through the same orifice as the one used when operating in after-glow. Parts colored in gray are filled with a gas that is capable of producing a plasma and the parts that are not colored are under vacuum. The flow of gases used is controlled by means of a mass flow-meter. The main steps for implementing the processes are commented hereinafter.

In a first step, as shown in FIGS. 1A and 2A, the exterior of the tube (110) as well as its wrapping (120) are subject to sterilization by after-glow, preferably according to one of the processes already described in the publication of M. Moisan, S. Moreau, M. Tabrizian, J. Pelletier, J. Barbeau and L'H. Yahia entitled “Process for Sterilizing Objects with Plasma” or in the Canadian Patent Application filed on May 28, 1999 and identified under number CA-A-2,273,432, in the name of Université de Montreal. To do this, the active species are from a source of plasma with a diameter typically of 25-30 mm. During this step, the mouthpieces that are intended to be inserted on the outer faces of the duct ends, are also sterilized.

In a second step (FIGS. 1B and 1A), it is the interior of the duct (110) that is subject to sterilization, this time by means of a surface wave plasma that extends along its entire length. To do this, first, an articulated arm provided with pliers (not illustrated in FIG. 1) is preferably used in order to insert the end of the duct on the (dielectric) mouthpiece (180) of the tube (110) (dielectric) that carries the surface wave exciter (150); the mouthpiece (180) of this tube connects up to the outer face of the duct (110); another mouthpiece (180) of the same type connects the duct outlet to the pump group. Once the “interior” sterilization is terminated, the articulated arm (not shown) (always under sterile condition) is used to remove the two mouthpieces (180) from the duct (110).

In a third step, the articulated arm is used to insert the duct in a wrapping bag that is sealed, for example, under heat (thermo-welding).

In a fourth step, the sterilization chamber (100) may then be opened and the wrapped duct is recovered and transferred into the room where it may either be used immediately, or stored.

The process described above is given by way of example, and other variants that use a surface wave plasma, may be used to sterilize the interior of the tube.

Thus, among the many possible variants, in the second step already described, the end of the duct opposed to the gas inlet, may remain free. Pumping and exhausting of the effluents is then carried out as in the first step (FIG. 2B).

According to another variant, the wave launcher is positioned inside the chamber and is placed half way in the duct, thereby providing a better axial uniformity of the plasma in the duct.

Finally, according to another embodiment, it is possible to reverse the order of the two previously described steps, and this as long as it appears to be easier, even faster, to slide the duct in the launcher as well as to insert the mouthpieces on the duct even before starting the sterilizing operations, while the sterilization chamber is opened to free air.

Sterilization Gas

A sterilization gas is used for the production of the plasma after-glow and for the production of the surface wave inside the essentially dielectric object to be decontaminated.

The two Patent Applications EP-A-00.930.937.8 and PCT/CA03/01116 describe particularly advantageous embodiments of sterilization by plasma after-glow, with a N₂—O₂ mixture (see also M. Moisan, S. Marceau, M. Tabrizian, J. Pelletier, J. Barbeau. L'H. Yahia, “Process for Sterilizing Objects with Plasma” and Canadian Patent Application, filed under serial number (May 28, 1999), 2,273,432 in the name of the Université de Montreal), or with pure argon, or other rare gases or gas mixtures as described in the publication of M. Moisan, N. Philip, B. Saoudi entitled “High Performing Process for Low Temperature Plasma Gas Sterilization” and Canadian Application number 2,395,659 filed on Jul. 26, 2002, in the two cases thanks to UV photons.

A good uniformity of the active sterilizing species is obtained in the after-glow chamber preferably with a mixture of N₂—O₂. It should be noted however that the N₂—O₂ mixture is more abrading on materials than argon, and this, because of the presence of atomic oxygen that is provided with a high chemical reactivity. Thus, argon may be used for sterilizing the interior of the hollow tube. The problem of spatial non uniformity of the active species does not exist, while the exterior of the duct may advantageously be sterilized by after-glow with a suitable mixture of N₂—O₂. Thus, abrasion of the duct, which is the most delicate part of this device, is minimized.

In the step of sterilizing the interior of the duct with a surface wave, the gas flow of the discharge is adjusted to a level:
that is sufficiently low not to produce an important pressure gradient in the duct; and
that is sufficiently high to ensure a good renewal of the gas and exhaust of the sterilization effluents.

Indeed, sterilization conditions for rare gases such as argon depend in a critical manner on the local pressure of the gas, because the latter acts on the intensity of emission of the UV photons as described in the publication of M. Moisan and of A. Ricard published in Can. J. Physics 55, 1010-1012 (1977). It should be noted that when there is an important pressure gradient, the pressure or the gas flow must be adjusted again during sterilization so that each duct section is successively at an optimal pressure and receives a maximum flow of photons.

Surface Wave Launcher

There are an important number of surface wave launchers that can be used for the purposed indicated. In the device described, an exciter called Ro-box, mentioned in U.S. Pat. No. 4,810,933, was preferably adopted.

Examples of Hollow Ducts

In a particularly advantageous manner, endoscopes for example those described in the U.S. Pat. No. 6,471,639 whose content is incorporated by reference into the present Application, catheters or hollow ducts assemblies with parallel axes disposed in a cylindrical or oblong wrapping, were sterilized.

Other Device

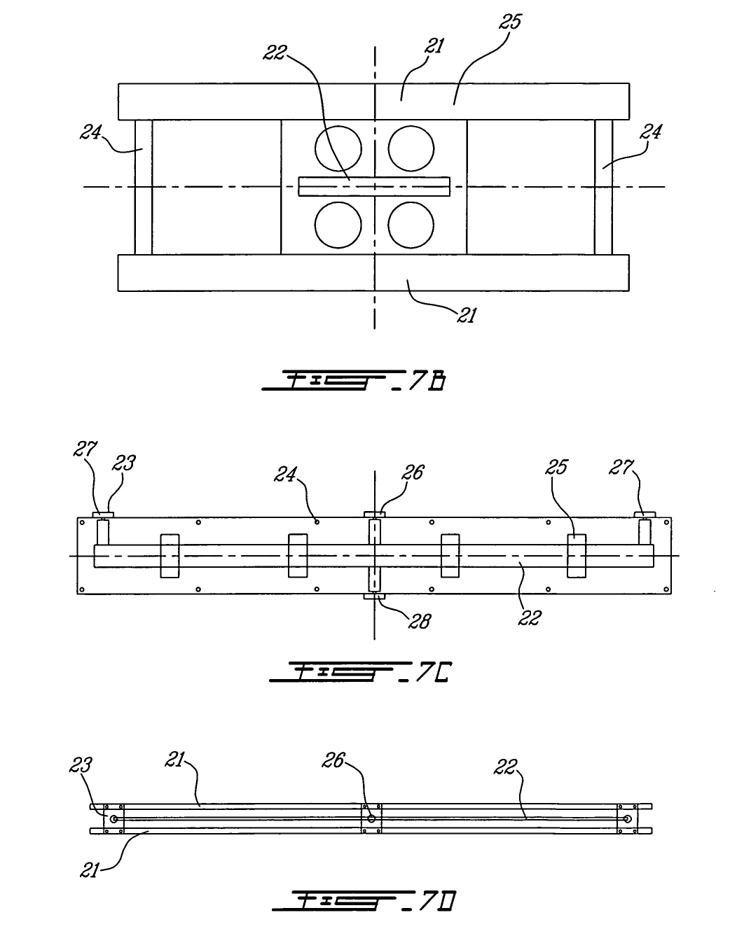

The FIGS. 7A, 7B, 7C and 7D represent an experimental device according to the invention that makes use of a tri-plate applicator. Element (1) represents an HF generator, (2) an adapted charge, (3) a circulator, (4) a bi-directional line, (5) a trigger-circuit (switch), (6) a bolometer, (7) a bottle of gas, (8) a gas flux dividing system, (9) a short-circuit piston for impedance tuning, (10) a tri-plate applicator and (11) a pumping system. FIG. 7B represents a transverse cross-section of the tri-plate applicator illustrated by reference 10 in FIG. 7A with Teflon™ spacers holding tubes not illustrated. With (21) that represents a metallic plate, (22) a central conductive band, (23) a connector N, (24) a metal spacer, (25) a Teflon™ spacer, (26) a power input, (27) a possible service line for matched charges and (28) a possible service line of a short-circuit piston for impedance tuning. FIG. 7C represents a view from above of the device of FIG. 7A and FIG. 7B, with the upper plate removed from the tri-plate system. FIG. 7D represents a side view without tubes and spacers.

### EXAMPLES

The following examples reported hereinafter are given purely by way of illustration and should not be interpreted as constituting any kind of limitation to the claimed object.

### Example 1

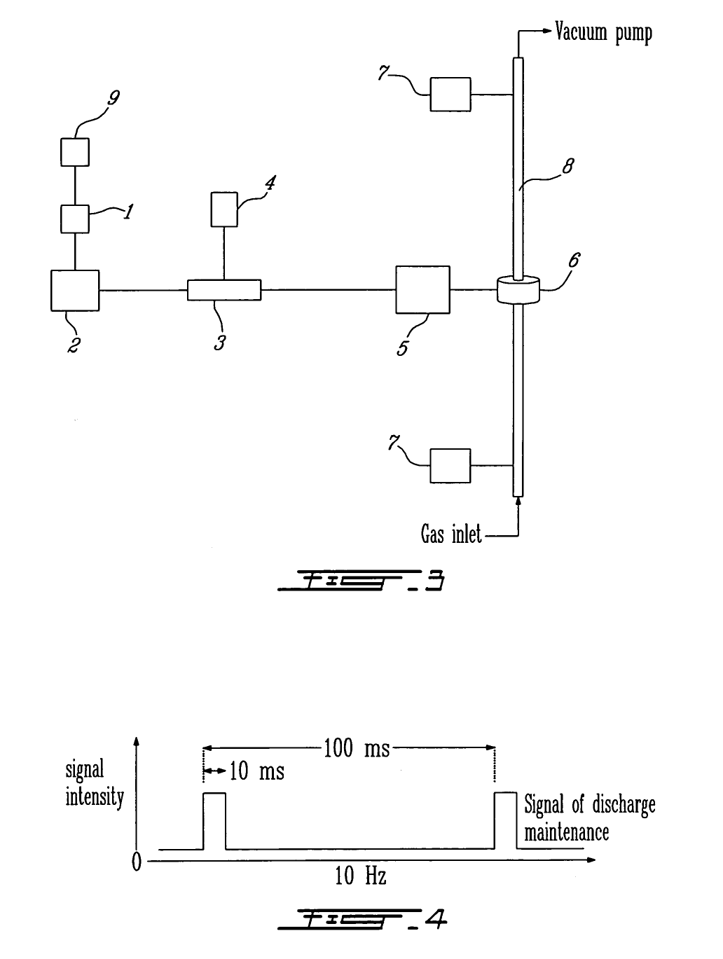

### Experimental Assembling and Corresponding Results Concerning the Use of Surface Wave Discharge for the Inactivation of B. subtilis Spores Introduced into a Hollow Tube—FIG. 3.

This assembling shows how to use the propagation of a surface wave to produce a plasma inside a hollow tube of dielectric material without damaging the latter with heat and how to control the value of the gas temperature of the gas discharge to obtain this result. The temperature of the exterior of the hollow tube is advantageously measured with a thermocouple.

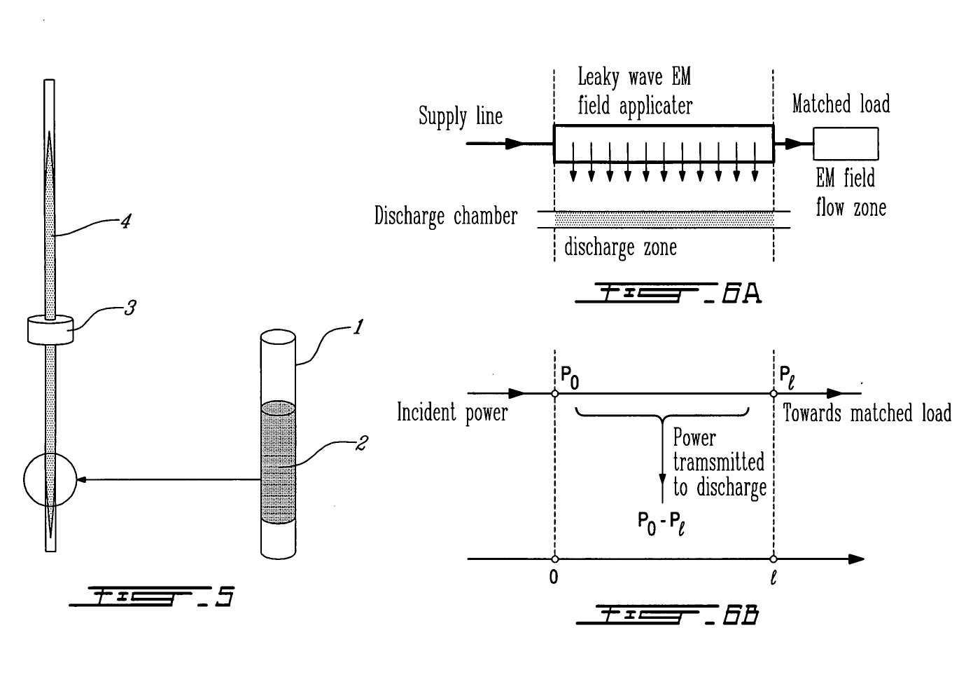

This embodiment of the process of the invention makes it possible to sterilize the interior of a hollow tube. In FIG. 5, element (1) represents the discharge tube, (2) the cross-section of tube 1 cm long and made of Teflon™, whose interior is contaminated, (3) a robox surface wave exciter and (4) the plasma.

The high frequency (HF) power input consists of an amplifier controlled by an oscillator, whose frequency is fixed at 100 MHz in the example. Emission of the oscillator is interrupted at a given fixed interval as determined by a computer. One of the selected modes of operations is a gap impulse lasting 10 milliseconds followed by an idle period of 90 milliseconds, giving rise to a rhythmical pace for the impulsion, of 10 Hz (FIG. 4).

The fact of not continuously feeding the discharge permits to adjust the temperature of the gas that is in the hollow tube of which the interior is intended to be sterilized without damaging the material of which it is made. The longer the duration of the idle period, the cooler is the discharge in the hollow tube. On FIG. 4, it will be noted that the control signal of the oscillator does not go exactly to zero during the so-called idle period, which makes it possible to maintain a minimum discharge (very short length), thus avoiding to have to restart the setting up of a minimum discharge by means of an outside impulse.

The frequency of operation was lowered to the lowest value that is compatible with the impedance coupler used (circuits L (inductance) and C (capacitance) in air), such as 100 MHz, was also used for decreasing gas heating.

It appeared of interest to modify the assembling in order to be able to operate at a still lower frequency, for example a few hundreds of kHz, however in this case a coupler impedance system of a different, heavier type, must be used.

The main part of endoscopes is made of Teflon™, which is an excellent dielectric material but which does not put up with temperatures that are too high. It is considered that the maximum temperature to be used to make sure that the integrity of Teflon™ is maintained, is in theory 260 degrees Celsius. However, in practice, to prevent any deformation of Teflon™ as well as of the polymer that coats Teflon™ (often polyurethane), the temperature must be kept below 60 degrees Celsius.

### Example 2

### Use of Two Different Gases to Carry Out Sterilization

A) In a first case, pure argon was used to produce, inside the hollow tube, a gas discharge with a power HF of 100 MHz, by propagating a surface wave. The discharge takes place in a quartz tube (molten silica) with 3 mm internal diameter (tube in which sections 1 cm long of a Teflon™ tube, contaminated with B. subtilis, see FIG. 5, were slid). To make sure that the discharge is uniform along the hollow tube, a very small discharge of gas (≦0.3 cm³/min.) was used. Pressure was fixed at 0.3 Torr, a value that was determined from results obtained in 26 mm tubes described in the publication of M. Moisan, N. Philip, B. Saoudi, entitled “High Performing System and Process for Sterilizing with Gas Plasma at Low Temperature” and in Canadian Application number 2,395,659 filed on Jul. 26, 2002, supposing that the intensity of UV emission directly depends on electronic temperature, which depends on a law of similars in pR (product of pressure P times radius R of the tube). Heating of the tube is then low, less than 40 to 50 degrees Celsius for operating conditions with impulse in uniform gap (active time=dead time) of 10 Hz of rhythmical pace.

In corresponding FIG. 3, element (1) represents the oscillator, (2) the amplifier, (3) the bidirectional line of power measurement, (4) the bolometer, (5) the impedance coupling box, (6) the robox surface wave exciter, (7) the gas pressure gauge, (8) the discharge tube, (9) the function generator (computer).

It was also noted that it was possible to sterilize the contaminated Teflon™ section in about 15 minutes. The maximum level of UV intensity at the pressure that was used could be optimally adjusted by proceeding to a measurement of the absorption that gives the density of population of the state of higher energy of the transition that emits UV photons.

B) A mixture of N₂—O₂ was used in which the percentage was fixed, by means of an optical spectrometer, so as to maximize the UV intensity that is emitted at 305 nm by direct observation of the discharge light by means of an optical spectrometer. The discharge took place at 100 MHz in a tube with a diameter of 3 mm and the pressure was fixed at about 0.3 Torr, the flow being very weak as in the case of argon. Under continuous operation of HF supply, the discharge was too hot, and it is therefore necessary to use a system of operation with idle period as described in example 1 (FIG. 4). This system of operation gives rise to a temperature that does not exceed 40 Celsius.

### Example 3

### Linear Shaped Applicator of Micro-Wave Field Disposed Along the Hollow Tube to be Sterilized and on the Exterior Side Thereof

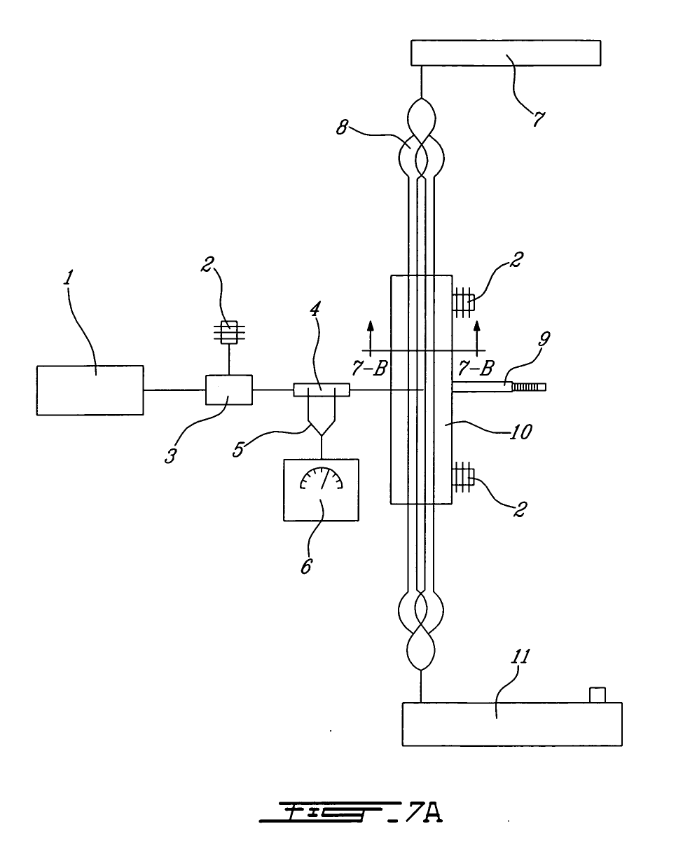

First, there is described the block diagram of the principle based on resorting to a linear sterilizing applicator. With reference to FIG. 6, the micro-wave power flux that is transmitted by the generator to the feeding line flows through openings in the structure of the applicator giving rise to an electrical field that allows to provide a discharge in the tube facing it, in parallel fashion. Power that is not used at the end of the applicator is dissipated in a so-called matched charge (in order to avoid a reflection of the EM wave at the end of the applicator). It is possible to imagine such a system wherein the density of the plasma produced is uniform along the tube to be sterilized. The advantage of this system is that it produces a plasma of much lower density than that of the surface wave. Thus, we can use a HF supply operating at 915 MHz and in continuous manner (no dead time) without unduly heating the discharge tube. The main disadvantage seems to be a loss of power in final instance (price to pay to ensure uniformity of discharge along the tube). The use described here of a linear applicator concerns only the sterilization of the interior of the hollow tube. To sterilize its exterior, this system must be implanted in the after-glow chamber described in FIGS. 1 and 2.

Bibliographical References

M. Moisan and A. Ricard, Can. J. Physics 55, 1010-1012 (1977).

M. Moisan, S. Moreau, M. Tabrizian, J. Pelletier, J. Barbeau, L'H. Yahia, “Process for Sterilization of Objects with Plasma” (Canadian Patent Application, serial number of filing (May 28, 1999), 2,273,432 in the name of Université de Montreal.

M. Moisan, S. Moreau, M. Tabrizian, J. Pelletier, J. Barbeau, L'H. Yahia, “System and Process of Sterilization by Gas Plasma at Low Temperature”, International Patent Application (Patent Cooperation Treaty (PCT)), number PCT/CA00/00623 (May 26, 2000) in the name of Université de Montreal. Publication of this Application under number WO 00/72889 dated Dec. 7, 2000.

M. Moisan, N. Philip, B. Saoudi, “High Performing System and Process for Low Temperature Plasma Gas Sterilization”, Canadian Patent Application Number 2,395,659 filed Jul. 26, 2002.

M. Moisan. Z. Zakrzewski, U.S. Pat. No. 4,810,933 (Mar. 7, 1989).

M. Moisan, Z. Zakrezewski, “Plasma Sources Based on the Propagation of Electromagnetic Surface Waves”. J. Phys. D: Appl. Phys. 24, 1025-1048 (1991).

Although the present invention has been described by means of specific implementations, it is understood that many variations and modifications may be grafted to the implementations, and the present invention aims at covering such modifications, uses or adaptations of the present invention following in general, the principles of the invention and including any variation of the present description which will become known or conventional in the field of activity in which the present invention is found, and that may apply to the essential elements mentioned above, in accordance with the scope of the following claims.

1. A process for sterilizing a dielectric contaminated object having at least one hollow part, said process comprising:
a) producing a plasma by submitting a gas or a mixture of gases to an electromagnetic field;
b) treating the exterior of said object by means of an after-glow of said plasma; and
c) treating said at least one hollow part of said object by means of a discharge of said plasma, said discharge being produced inside said at least one hollow part,
wherein step (c) is carried out before or after step (b).

2. The process of claim 1, wherein said gas comprises molecular oxygen, nitrogen, neon, argon, krypton, xenon, helium, oxygen, carbon monoxide, carbon dioxide, gases of formula NOₓ, in which x represents a whole number selected from the group consisting of 1, 2 or 3, or air.

3. The process of claim 1, wherein said mixture of gases comprises at least two gases selected from the group consisting of molecular oxygen, nitrogen, neon, argon, krypton, xenon, helium, oxygen, carbon monoxide, carbon dioxide, gases of formula NOₓ, in which x represents a whole number selected from the group consisting of 1, 2 or 3, and air.

4. The process of claim 1, wherein said mixture of gases is a mixture of N₂ and O₂.

5. The process of claim 1, wherein the electromagnetic field is one produced by a surface wave.

6. The process of claim 1, wherein the contaminated object is a cylindrical hollow duct.

7. The process of claim 6, wherein the ratio obtained by dividing the length of the cylinder that constitutes the contaminated object by the diameter of the cylinder is between 5.10³ and 0.3.10³.

8. The process of claim 6, wherein said hollow duct includes at least two free ends, each end being provided with a dielectric mouthpiece and positioned in a sterilization chamber so that a first mouthpiece is in contact with a surface wave exciter and that a second mouthpiece is connected to a pump system that exhausts effluents from the discharge.

9. The process of claim 1, wherein the contaminated object is a hollow tube.

10. The process of claim 1, wherein treatment of the hollow part(s) with the electromagnetic surface wave lasts between 45 and 120 minutes and/or the temperature in the hollow tube, during the treatment, is between 30 and 60 degrees Celsius.

11. The process of claim 1, wherein the frequency of excitation of the plasma during the discharge is between 10 kHz and 10 GHz.

12. The process of claim 1, wherein the frequency of excitation of the plasma during the discharge is between 1 MHz and 2500 MHz.

13. The process of claim 1, wherein a wrapping adapted to receive said object is treated during said after-glow.

14. The process of claim 13, wherein the interior part of the wrapping is oriented to face a source where said after-glow plasma is produced.

15. The process of claim 13, wherein, once sterilization is over, the sterilized object is transferred, while keeping a sterile environment, into said wrapping that is present in a chamber where said process is carried out.

16. The process of claim 15, further comprising the step of sealing said wrapping containing the sterilized object by a thermo-welding process.

17. The process of claim 1, wherein said object is selected from the group consisting of endoscopes, catheters and hollow ducts assemblies with parallel axes disposed in a cylindrical or oblong envelope.

18. The process of claim 1, wherein the hollow part of said object is first treated, and the exterior of said object is thereafter treated.

19. A process for sterilizing a dielectric contaminated object having at least one hollow part, said process comprising:
a) producing a first plasma by submitting a gas or a mixture of gases to an electromagnetic field;
b) treating the exterior of said object by means of an after-glow of said first plasma;
c) producing a second plasma by submitting a gas or a mixture of gases to an electromagnetic field; and
d) treating said at least one hollow part of said object by means of a discharge of said second plasma, said discharge being produced inside said at least one hollow part,
wherein step (c) is carried out before or after step (a) and/or step (b), and step (d) is carried out after step (c).

20. The process of claim 19, wherein said gas in step (a) comprises molecular oxygen, nitrogen, neon, argon, krypton, xenon, helium, oxygen, carbon monoxide, carbon dioxide, gases of formula NOₓ, where x represents a whole number selected from the group consisting of 1, 2 or 3, or air.

21. The process of claim 19, wherein said mixture in step (a) comprises at least two gases selected from the group consisting of molecular oxygen, nitrogen, neon, argon, krypton, xenon, helium, oxygen, carbon monoxide, carbon dioxide, gases of formula NOₓ, where x represents a whole number selected from the group consisting of 1, 2 or 3, and air.

22. The process of claim 19, wherein said gas in step (c) comprises molecular oxygen, nitrogen, neon, argon, krypton, xenon, helium, oxygen, carbon monoxide, carbon dioxide, gases of formula NOₓ, where x represents a whole number selected from the group consisting of 1, 2 or 3, or air.

23. The process of claim 19, wherein said mixture in step (c) comprises at least two gases selected from the group consisting of molecular oxygen, nitrogen, neon, argon, krypton, xenon, helium, oxygen, carbon monoxide, carbon dioxide, gases of formula NOₓ, where x represents a whole number selected from the group consisting of 1, 2 or 3, and air.

24. The process of claim 19, wherein the first plasma is produced from a mixture of N₂ and O₂.

25. The process of claim 19, wherein the second plasma is produced from argon.

26. A device for sterilizing a dielectric contaminated object and having at least one hollow part, said device comprising:
a sterilization chamber adapted to receive said object;
a first plasma source in communication with said chamber, and adapted to produce a plasma to be used for treating the exterior of said object through an after-glow;
a second plasma source in communication with said chamber, and adapted to produce a plasma to be used for treating said at least one hollow part of said object by means of a discharge, said second source comprising a mouthpiece dimensioned so that when the latter is coupled with the hollow part of said object, said discharge is produced inside the hollow part; and
an outlet in communication with said chamber and allowing to exhaust gases produced in said chamber.

27. The device of claim 26, further comprising another outlet in communication with said chamber, said another outlet comprising a mouthpiece dimensioned so that when the latter is coupled with the hollow part of said object, gases produced inside the hollow part, during the discharge, are exhausted through the latter so as to avoid contact of the gases with said object.

28. The device of claim 26, characterized in that said object is a hollow tube, and in that one of the ends of the tube is adapted to be coupled with the mouthpiece of the second plasma source, and that the other end of the hollow tube is adapted to be coupled with the mouthpiece of the other outlet, so that the discharge is carried out inside the tube thereby avoiding contact between the exterior of the tube and the second plasma, its discharge and the gases produced during the latter.

29. The device of claim 28, wherein the sterilization chamber includes one or more supports.

30. The device of claim 29, wherein the support(s) are adjustable with respect to their position in said chamber.

31. The device of claim 26, wherein said sterilization chamber includes means for handling said object placed therein in a sterile manner.
